(19) United States
(12) Patent Application Publication
(10) Pub. No.: US 2017/0015275 A1
(43) Pub. Date: Jan. 19, 2017

(54) PRELOCK PREVENTION DEVICE FOR USE WITH A WEB RETRACTOR AND ASSOCIATED SYSTEMS AND METHODS

(71) Applicant: Shield Restraint Systems, Inc., Elkhart, IN (US)

(72) Inventor: John Clark, Granger, IN (US)

(21) Appl. No.: 14/802,792

(22) Filed: Jul. 17, 2015

(51) Int. Cl. B60R 22/41; B60R 22/38

(52) U.S. Cl. CPC B60R 22/41; B60R 22/38

(57) ABSTRACT

A prelock prevention device for use with a web retractor in a vehicle restraint system is described herein. The web retractor can include a sidewall adjacent a rotatable spool with a web wound thereon. A prelock prevention device configured in accordance with aspects of the present technology can include a base having a first flange portion spaced apart from a second flange portion to define a space therebetween. At least one of the first flange portion or the second flange portion is resiliently biased toward the other of the first flange portion or the second flange portion to grip an edge portion of the retractor sidewall sandwiched therebetween. The prelock prevention can further include an arm resiliently supported by the base and having a contact surface configured to compress the web against the spool during rotation thereof to reduce web retraction velocity.

### TECHNICAL FIELD

The present technology relates generally to prelock prevention devices for use with web retractors, and associated systems and methods.

### BACKGROUND

Seat belt systems for use in automobiles, aircraft, and other vehicles typically include a belt or web that can be pulled from a web retractor and extended across an occupant's body. The web retractor can be fixedly attached to a seat or other mounting structure on one side of the occupant. The free end of the web typically carries a connector tongue that can be releasably engaged with a buckle anchored to the base of the seat or floor opposite the web retractor. Conventional web retractors typically include a spring-loaded, rotatable spool that maintains tension on the web and retracts it when the connector tongue is released from the buckle. Web retractors can also include a locking mechanism that automatically locks the spool during a crash or other significant dynamic event to prevent the web from being extracted and restrain the occupant in the seat.

In certain instances, the locking mechanism can inadvertently lock the spool during a non-crash event. For example, when the occupant releases the web and lets it retract back into the retractor, the connector tongue on the free end of the web can impact the retractor with such force that it causes the locking mechanism to lock the spool. This prevents the occupant or a subsequent occupant from extracting the web for resuse without first having to manually disengage or unlock the locking mechanism.

### BRIEF DESCRIPTION OF THE DRAWINGS

FIG. 1A is an isometric view, and FIG. 1B is a cross-sectional isometric view taken from FIG. 1A, of a web retractor with a prelock prevention device configured in accordance with an embodiment of the present technology.

FIGS. 2A and 2B are isometric views, and FIG. 2C is a side view of the prelock prevention device of FIGS. 1A and 1B.

FIG. 3 is an isometric view of a restraint system having a web retractor with a prelock prevention device configured in accordance with an embodiment of the present technology.

### DETAILED DESCRIPTION

The present technology is directed to prelock prevention devices for use with web retractors and associated systems and methods. A prelock prevention device configured in accordance with an embodiment of the present technology can include, for example, an arm resiliently supported by a base. The arm can include a contact surface configured to compress a web against a spool of a web retractor to reduce the velocity of the web during retraction. Reducing the web retraction velocity can reduce the impact from a connector tongue striking the web retractor when the web is released by the seat occupant and quickly retracted onto the spool. Decreasing the impact force can prevent the web retractor locking mechanism from inadvertently locking the spool and hindering subsequent web extraction.

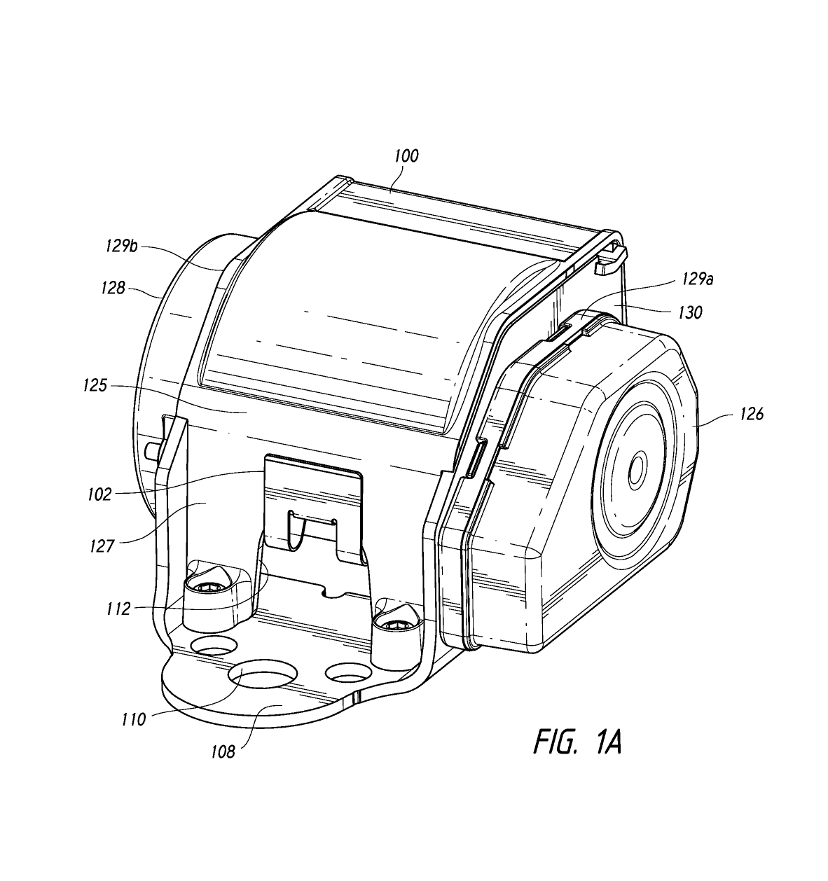

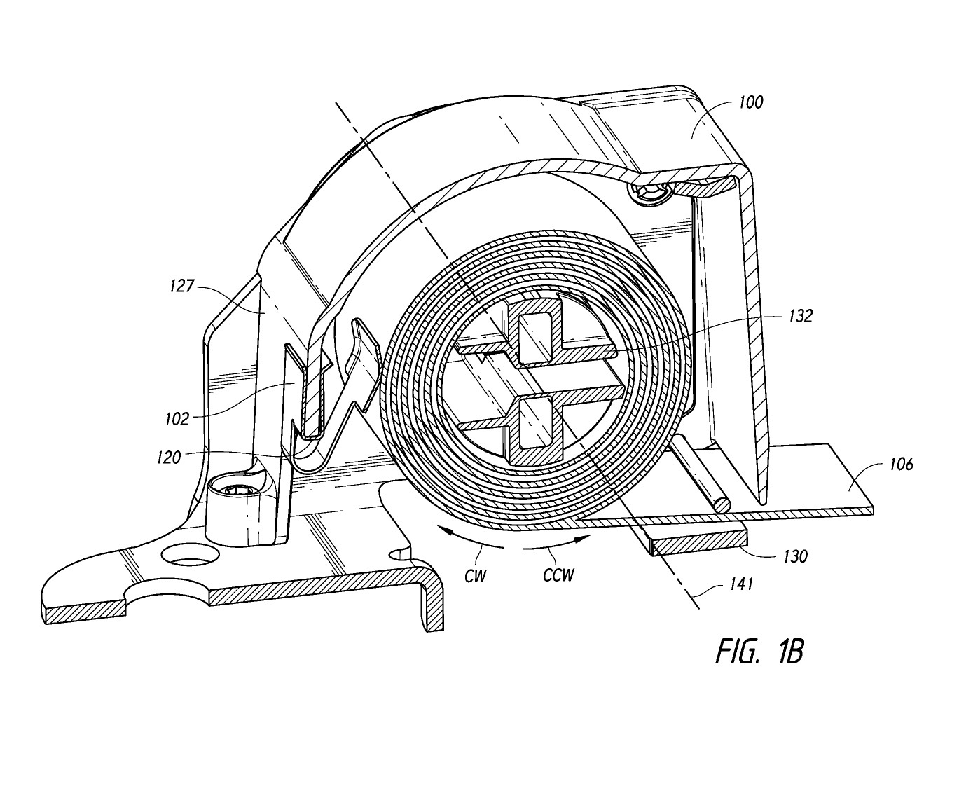

Certain details are set forth in the following description and in FIGS. 1A-3 to provide a thorough understanding of various embodiments of the present technology. Other details describing well-known structures and systems often associated with occupant restraint systems, web retractors, etc., however, are not set forth below to avoid unnecessarily obscuring the description of the various embodiments of the present technology.

Many of the details, dimensions, angles and other features shown in FIGS. 1A-3 are merely illustrative of particular embodiments of the present technology. Accordingly, other embodiments can include other details, dimensions, angles and features without departing from the spirit or scope of the present invention. In addition, those of ordinary skill in the art will appreciate that further embodiments of restraint systems, web retractors, and/or prelock prevention devices described herein can be practiced without several of the details described below. Various embodiments of the present technology can also include structures other than those illustrated in the Figures and are expressly not limited to the structures shown in the Figures. Moreover, the various elements and features illustrated in the Figures may not be drawn to scale.

In the Figures, identical reference numbers identify identical or at least generally similar elements. To facilitate the discussion of any particular element, the most significant digit or digits of any reference number refers to the Figure in which that element is first introduced. For example, element 110 is first introduced and discussed with reference to FIG. 1.

FIG. 1A is an isometric view, and FIG. 1B is a cross-sectional isometric view taken from FIG. 1A, of a web retractor 100 with a prelock prevention device 102 configured in accordance with an embodiment of the present technology. Referring to FIGS. 1A and 1B together, the web retractor 100 can be generally similar to conventional web retractors known in the art. For example, web retractors are described in U.S. Patent Publication No. 2014/0001299, entitled “SEATBELT RETRACTORS AND ASSOCIATED METHODS OF MANUFACTURE AND USE,” and in U.S. Patent Publication No. 2014/0054405, entitled “SEAT BELT RETRACTORS AND ASSOCIATED SYSTEMS AND METHODS,” both of which are incorporated herein by reference in their entireties. Those of skill in the art will understand, however, that the prelock prevention devices described herein are not limited to use with any particular web retractor configuration or arrangement.

The web retractor 100 can be fixedly attached to a vehicle (not shown) by means of bolts and/or other suitable fasteners known in the art. For example, the web retractor 100 can be mounted directly to an interior sidewall of a vehicle, a vehicle floor, a seat frame, and/or other equipment within a vehicle. In the illustrated embodiment, the web retractor 100 includes a frame 130 (e.g., a metal frame) having a mounting flange 108 with one or more apertures 110 configured to receive bolts or other suitable fasteners to fixedly attach the web retractor 100 to a portion of a vehicle.

The web retractor 100 can further include a locking mechanism cover or housing 126 and a spring assembly cover or housing 128 attached to opposing side walls 129 (identified individually as a first sidewall 129a and a second sidewall 129b) of the retractor frame 130. The locking mechanism housing 126 and the spring assembly housing 128 can be attached to the sidewalls 129 of the retractor frame 130 using screws, mating interfaces, snap locks, and/or other suitable attachment means known in the art. The locking mechanism housing 126 and the spring assembly housing 128 can be formed from plastic (e.g., injection-molded plastic) and/or other suitable materials known in the art. The retractor frame 130 can be made from metal (e.g., stamp-formed from a metal sheet or plate, etc.) and/or other suitable materials known in the art.

The retractor 100 also includes a spring-loaded spool 132 that can extend between the sidewalls 129 of the retractor frame 130. The spool 132 is operably coupled to a retractor mechanism (e.g., a torsion spring; not shown) stored within the spring assembly housing 128. The spool 132 carries a seat belt or web 106 (e.g., a lap web, shoulder web, etc.) wound thereon in a known manner. The web 106 can be used to secure an occupant in a vehicle in a conventional manner. For example, the occupant can extract the web 106 from the retractor 100 and releasably engage a connector carried by the distal end portion of the web 106 (not shown in FIGS. 1A and 1B) with a buckle anchored to a seat frame or other structure on the opposite side of the seat from the web retractor 100. In the illustrated embodiment, the spool 132 can rotate about a central axis 141 in a first direction (e.g., a clockwise direction CW) to retract and wind (e.g., take-up) the web 106 thereon. The spool 132 can also rotate about the axis 141 in a second direction (e.g., a counterclockwise direction CCW) opposite to the first direction to pay out the web 106 from the retractor 100. The retractor 100 can include features known in the art to fasten the web 106 to the spool 132. The retractor 100 can further include a retractor cover or housing 125 that at least partially encloses the retractor frame 130 and spring-loaded spool 132 and forms a barrier between the internal components of the retractor 100 and the external environment. The retractor housing 125 can be made from plastic and/or other durable materials. The retractor housing 125 can include a rear wall 127 extending between rear portions of the sidewalls 129.

The spring housing 128 encloses a spring assembly (not shown) generally similar to conventional spool spring assemblies known in the art. For example, the spring assembly can include a biasing member such as a driving coil or spring that is wound concentrically around and coupled to the spool 132. The driving spring can apply a biasing torque to the spool 132, which in turn exerts tension on the web 106 during extraction or pay out, and which drives the spool to retract or take-up the web when the web 106 is released or disengaged from a buckle. The driving spring can be made from an elastic metal (e.g., hardened steel) and/or another suitable material that can store sufficient energy to spring-load and drive the spool 132.

The locking mechanism housing 126 encloses a spool or web locking mechanism (not shown) generally similar to conventional locking mechanisms known in the art that lock or prevent the spool 132 from rotating in the second direction CCW during a crash or other significant dynamic event. For example, the locking mechanism can utilize inertial counterweights (e.g., spring-loaded lever arms) pivotally coupled to the spool 132 and configured to rotate outwardly and engage teeth on a lock ring and lock the spool 132 when the web 106 is extracted from the spool 132 at or above a preset rate (e.g., during a crash or other significant dynamic event). Extracting the web 106 above a preset rate provides a centrifugal force that drives the inertial counterweights outwardly and into engagement with the lock ring, thereby locking the spool 132 and preventing further pay out or extraction of the web 106. This restrains a passenger or occupant in the vehicle seat during a crash or similar event. Those of ordinary skill in the art will understand that prelock prevention devices described herein are not limited to use with any particular locking mechanism configuration or arrangement, and can be used with various other types of locking mechanisms.

In certain instances, the locking mechanism can be inadvertently caused to lock the spool 132. For example, in normal operation of a conventional web retractor, when an occupant releases or disengages the web 106 from a buckle, the spring-loaded spool 132 rotates in the first direction CW to wind the web 106 thereon. In absence of the prelock prevention device 102, the spool 132 can retract the web 106 at a sufficiently high rate of velocity that can, in some instances, cause the connector tongue on the end of the web 106 to strike the web retractor 100 (e.g., the frame 130) with sufficient force to cause the locking mechanism to engage the spool 132 and lock the web 106. For example, the connector tongue can strike the web retractor 100 with a force sufficient to drive the inertial counterweights of the locking mechanism into engagement with the lock ring and lock the spool 132. The occupant or a subsequent occupant will then have to manually disengage the locking mechanism prior to being able to extract and reuse the web 106. For example, the occupant may have to push the web 106 into the retractor 100 to allow the spool 132 to rotate in the first direction CW to allow the counterweights to pivot inwardly and out of engagement with the lock ring. Inadvertently causing the locking mechanism to lock in this manner is commonly referred to as retractor “prelock.”

The prelock prevention device 102 described herein can prevent or reduce the likelihood of retractor prelock. The prelock prevention device 102 can be clipped, clamped, fastened, or otherwise attached to a portion of the web retractor 100 (e.g., the retractor housing 125). For example, in the illustrated embodiment, the prelock prevention device 102 is attached to an edge portion 120 of an opening 112 in the rear wall 127 of the housing 125. In other embodiments, the prelock prevention device 102 can be integrally formed with a portion of the web retractor 100. The prelock prevention device 102 can be fitted (or retrofitted) to virtually any type of web retractor.

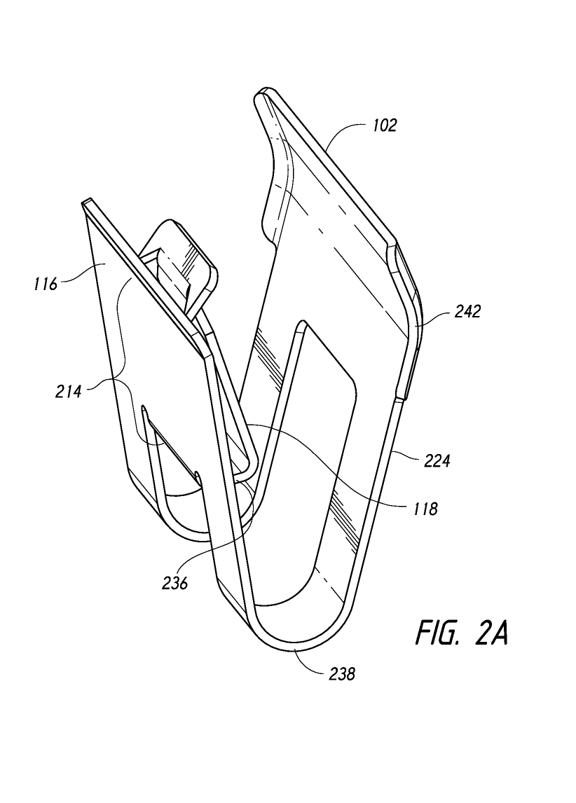

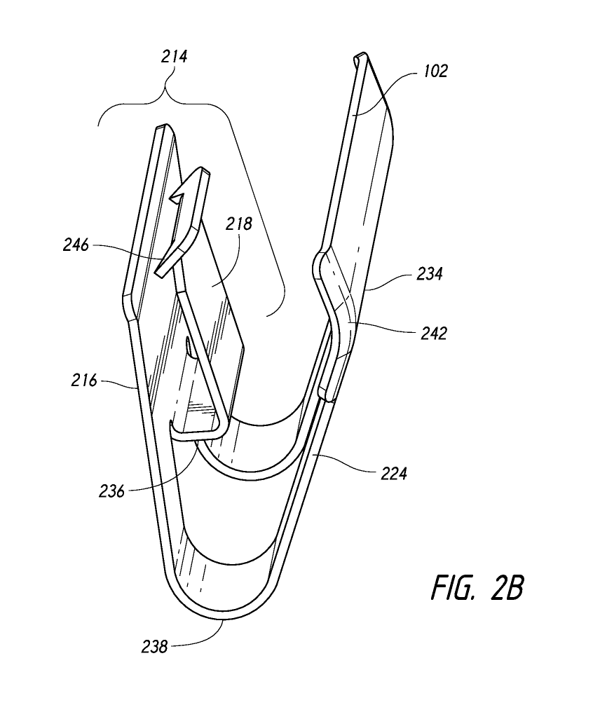

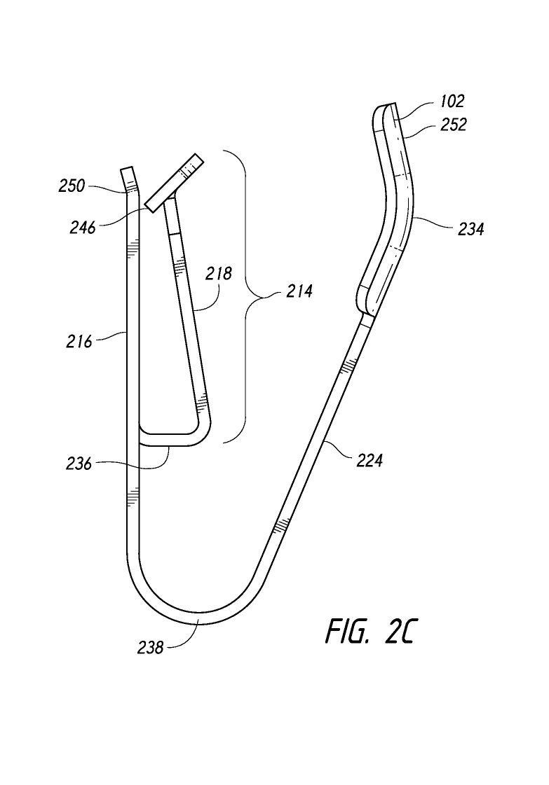

FIGS. 2A and 2B are isometric views, and FIG. 2C is a side view of the prelock prevention device 102 configured in accordance with an embodiment of the present technology. Referring to FIGS. 2A-2C together, in the illustrated embodiment, the prelock prevention device 102 includes a base 214 for removably attaching the prelock prevention device 102 to the web retractor 100. The base 214 includes a first flange portion 216 spaced apart from a second flange portion 218 by a first bight portion 236 disposed therebetween. As used herein, the term “bight” generally refers to a bend or curve. For example, a “bight portion” can have a generally U- or V-shape. The first flange portion 216, the second flange portion 218, and the first bight portion 236 can form a generally U-shaped cross-section that receives the edge portion 120 of the rear wall 127. The prelock prevention device 102 can be a unitary part stamped from a single piece of sheet metal or another suitable material and formed into the illustrated configuration.

In the illustrated embodiment, the first flange portion 216 can be resiliently biased toward the second flange portion 218 when the base 214 is installed on the edge portion 120 of the rear wall 127 (FIG. 1A). In other embodiments, the second flange portion 218 can be resiliently biased toward the first flange portion 216. In further embodiments, both the first flange portion 216 and the second flange portion 218 can be resiliently biased toward each other. The first flange portion 216 is reliantly biased toward the second flange portion 218 to facilitate mounting the prelock prevention device 102 to the retractor housing 125. For example, the base 214 can be installed on the edge portion 120 of the retractor housing 125 such that the edge portion 120 is sandwiched in between the first and second flange portions 216,218 as shown in FIG. 1B. The biasing of one or both of the flange portions 216,218 toward each other causes the base 214 to squeeze and grip the edge portion 120.

The second flange portion 218 (and/or the first flange portion 216) can include at least one barb feature 246 (e.g., an angled or sharp projection) on a distal end portion thereof. The at least one barb feature 246 can help further secure the prelock prevention device 102 to the web retractor 100. For example, due to vehicle movement and/or normal operation of the web retractor 100, both the web retractor 100 and the prelock prevention device 102 may have a tendency to move relative to each other. This can cause the base 214 to back off of the edge portion 120. The least one barb feature 246 can dig into or bear against the rear wall 127 to prevent or reduce back-out and secure the prelock prevention device 102 relative to the web retractor 100.

The prelock prevention device 102 includes an arm 224 resiliently supported by the base 214. For example, the arm 224 can be cantilevered from the base 214 in a reverse direction by a second bight portion 238 (e.g., a generally U- or V-shape). The base 214, the second bight portion 238, and the arm 224 can form a second generally V-shaped or U-shaped cross-section of the prelock prevention device 102. The second generally V-shaped or U-shaped cross-section can be larger than the first generally U-shaped cross-section formed by the first flange portion 216, the second flange portion 218, and the first bight portion 236.

The arm 224 further includes a contact surface 234 on a distal end portion 252 that is configured to compress the web 106 against the spool 132 (FIG. 1B) during rotation. The first flange portion 216 includes a distal end portion 250 that extends in generally the same direction as the distal end portion 252 of the arm 224. The main body portion of the contact surface 234 can be slightly rounded or curved. The opposing sides of the contact surface 234 can also include rounded or curved side edge portions 242. The curved contact surface 234 and side edge portions 242 can reduce wear on the web 106 in contrast to sharp or angled surfaces that can fray or tear the web 106 during use. The arm 224 can extend from the base 214 and form a torsion or leaf spring that compresses the web 106 between the contact surface 234 and the spool 132.

Referring to FIGS. 1A-2C together, in operation, the prelock prevention device 102 can prevent or at least reduce the likelihood of retractor prelock. When the prelock prevention device 102 is operably attached to the web retractor 100 as shown in FIGS. 1A and 1B, the second flange portion 218 is resiliently biased against the edge portion 120 in a first direction (e.g., away from the spool 132) to grip the edge portion 120 between the first flange portion 216 and the second flange portion 218. Additionally, the contact surface 234 is resiliently biased against the web 106 in a second direction (e.g., toward the spool 132) opposite the first direction and generally normal to the spool axis 141. When an occupant releases the web 106, the spring-loaded spool 132 quickly rotates and retracts the web 106 into the retractor 100 and onto the spool 132. As the spool 132 is rotating, the contact surface 234 compresses the web 106 against the spool 132, and the resulting friction from the contact surface 234 reduces the rotational speed of the spool 132 and hence the web retraction speed. As a result, the impact force from the connector tongue on the end of the web 106 striking the web retractor 100 is sufficiently reduced so that it does not cause the locking mechanism of the retractor 100 to inadvertently lock the spool 132. The occupant or subsequent occupant can then extract the web 106 for reuse without having to manually disengage the locking mechanism. In some embodiments, the contact surface 234 can be sufficiently spaced from the spool 132 such that the contact surface 234 only contacts the web 106 in the last few turns (e.g., rotations, winds, revolutions, etc.) of the web 106 around the spool 132 during web retraction. For example, the contact surface 234 can be positioned such that it only contacts the web 106 in about the last 1 to 8 turns, 1 to 6 turns, 1 to 4 turns, and/or about any amount of turns therebetween during web retraction.

In operation, the prelock prevention device 102 increases the pressure on the web 106, and hence the friction, proportional to the diameter of the wound web. Hence, the closer the web 106 is to being fully retracted, the greater the pressure. As more of the web 106 is retracted, more of the web is taken-up or wound onto the spool 132. The wound web drives the contact surface 234 toward the base 214, thereby increasing the pressure on the web 106.

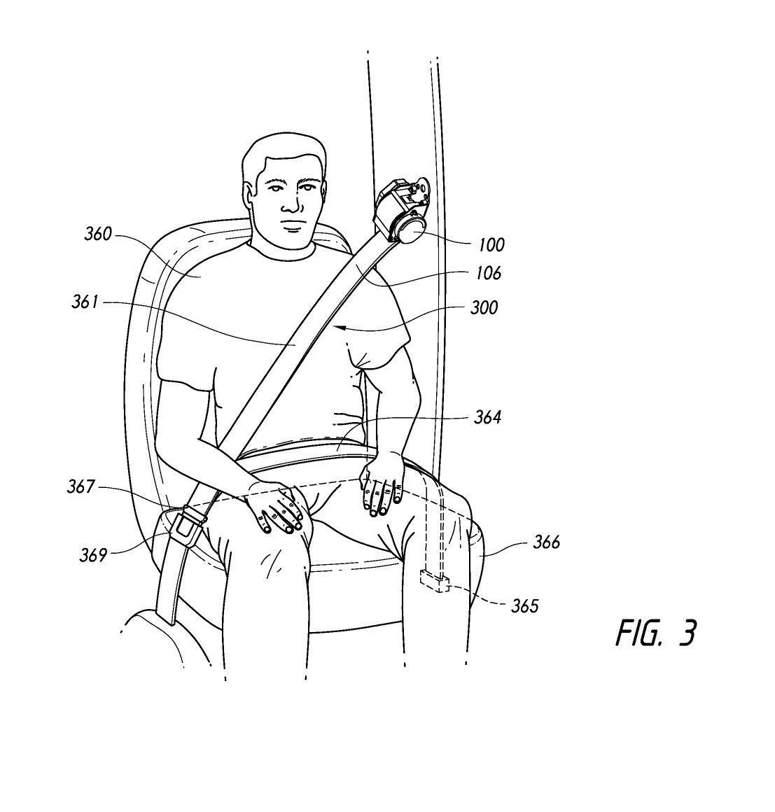

FIG. 3 is an isometric view of a restraint system 300 having the web retractor 100 with the prelock prevention device 102, in accordance with an embodiment of the present technology. In the illustrated embodiment, the restraint system 300 can be a seat belt system used to secure an occupant 360 in a vehicle such as a car, UTV, aircraft, etc. The web retractor 100 can be fixedly attached to an upper sidewall portion of the vehicle adjacent to the occupant's shoulder. The web 106 can be a conventional seat belt web made of woven nylon or other suitable materials known in the art. The web 106 extends downwardly from the web retractor 100 across the shoulder of the occupant 360 to form a shoulder web portion 361. The web 106 can also extend through a belt connector tongue 367 that releasably engages a buckle 369 anchored to the floor of the vehicle. The web 106 extends from the tongue 367 to form a lap web portion 364 fixedly attached to an anchor 365 on the floor of the vehicle adjacent to the seat 366 and opposite the buckle 369. The wall-mounted retractor 100 can facilitate extension and retraction of the web 106 for installation and removal of the shoulder web portion 361 and the lap web portion 364 on and from the occupant 360. In further embodiments, the retractor 100 can be mounted to other portions of the vehicle (e.g., the vehicle floor), and/or to other equipment within the vehicle (e.g., a car seat).

When the occupant 360 releases or disengages the connector tongue 367 from the buckle 369, the web 106 is retracted into the web retractor 100 and wound onto the spool 132 as described above. The prelock prevention device 102 reduces the web retraction velocity by bearing against the web 106 with increasing force to provide a frictional force that is counter to the direction of web travel, thereby reducing the impact force of the connector tongue 367 striking the web retractor 100. This reduces or prevents the locking mechanism of the web retractor 100 from locking the spool 132. The occupant 360 or subsequent occupant can then freely extract the web 106 from the web retractor 100 across their body for reuse by extending the web 106 and reengaging the tongue 367 with the buckle 369.

Although FIG. 3 illustrates one possible configuration of a seat belt system, those of ordinary skill in the art will appreciate that the web retractors disclosed herein can be suitably employed in a wide variety of seat belt systems and vehicles with which seat belt web retractors are used. In other embodiments, for example, the restraint system 300 can include additional webs (e.g., additional shoulder webs, etc.) and corresponding retractors. For example, the restraint system 300 can additionally include a second shoulder web portion 361 that can be deployed from a second retractor 100 anchored to a rear portion of the seat 366. Accordingly, those of skill in the art will understand that the web retractor prelock prevention devices described herein are not limited to use in any particular configuration or arrangement.

From the foregoing, it will be appreciated that specific embodiments have been described herein for purposes of illustration, but that modifications may be made without deviating from the spirit and scope of the various embodiments of the present technology. Specific elements of any of the foregoing embodiments can also be combined or substituted for elements in other embodiments. Furthermore, while advantages associated with certain embodiments of the present technology have been described in the context of these embodiments, other embodiments may also exhibit such advantages, and not all embodiments need necessarily exhibit such advantages to fall within the scope of the technology. Accordingly, the present technology is not limited, except as by the appended claims.

I/We claim:

1. A prelock prevention device for use with a web retractor, the web retractor having a sidewall adjacent a rotatable spool having a web wound thereon, the prelock prevention device comprising:
a base having a first flange portion spaced apart from a second flange portion to define a space therebetween, wherein at least one of the first flange portion or the second flange portion is resiliently biased toward the other of the first flange portion or the second flange portion to grip an edge portion of the retractor sidewall sandwiched therebetween; and
an arm resiliently supported by the base, wherein the arm includes a contact surface configured to compress the web against the spool during rotation thereof.

2. The device of claim 1 wherein the base and the arm are formed from a unitary piece of sheet metal.

3. The device of claim 1 wherein the arm forms a torsion spring that compresses the web between the contact surface and the spool.

4. The device of claim 1 wherein the arm is cantilevered from the base.

5. The device of claim 1 wherein the first flange portion extends generally parallel to the second flange portion when the edge portion of the retractor sidewall is sandwiched therebetween.

6. The device of claim 1, further comprising a bight portion disposed between the base and the arm, wherein the base, the bight portion, and the arm define a U-shaped cross-section.

7. The device of claim 1 wherein the first flange has a first distal end portion, wherein the contact surface has a second distal end portion, and wherein the arm is cantilevered from the base in a U-shaped arrangement in which the first and second distal end portions extend toward the same direction.

8. The device of claim 1, further comprising a bight portion disposed between the first flange portion and the second flange portion, and wherein the first flange portion, the second flange portion, and the bight portion define a U-shaped cross-section.

9. The device of claim 1 wherein the second flange portion is resiliently joined to the first flange portion by a bight portion disposed therebetween, wherein the first flange portion, the second flange portion, and the bight portion define a U-shaped cross-section, and wherein the second flange portion includes at least one barb feature on a distal end thereof configured to grip the edge portion of the retractor sidewall.

10. The device of claim 1 wherein:
the second flange portion is resiliently joined to the first flange portion by a first bight portion disposed therebetween,
the first flange portion, the second flange portion, and the first bight portion define a first U-shaped cross-section,
the arm is resiliently joined to the base by a second bight portion disposed therebetween,
the base, the second bight portion, and the arm define a second U-shaped cross-section, and
the second U-shaped cross-section is larger than the first U-shaped cross-section.

11. The device of claim 1 wherein the second flange portion is resiliently biased toward the first flange portion in a first direction when the device is operably attached to the retractor, and wherein the contact surface is resiliently biased against the web in a second direction, opposite to the first direction, when the device is operably attached to the retractor.

12. A web retractor comprising:
a housing;
a spool rotatably disposed in the housing;
a web wound around the spool; and
a prelock prevention device, wherein the prelock prevention device includes—
a base operably coupled to the housing; and
a generally U-shaped arm extending from the base, wherein the arm includes a contact surface at a distal end portion thereof in sliding contact with the web, and wherein the arm forms a torsion spring that compresses the wound web between the contact surface and the spool.

13. The retractor of claim 12 wherein the housing includes an opening in a sidewall thereof, and wherein the base is removably coupled to an edge portion of the sidewall with the arm extending through the opening.

14. The retractor of claim 12 wherein the prelock prevention device is retrofitted onto the web retractor.

15. The retractor of claim 12 wherein the base includes a first flange portion spaced apart from a second flange portion to define a space therebetween, wherein at least one of the first flange portion or the second flange portion is resiliently biased toward the other of the first flange portion or the second flange portion to grip an edge portion of the housing.

16. The retractor of claim 12 wherein at least one of the first and second flange portions includes a barbed feature on a distal end thereof configured to grip the edge portion of the housing.

17. The retractor of claim 12 wherein the first flange portion extends generally parallel to the second flange portion when the edge portion of the housing is sandwiched therebetween.

18. The retractor of claim 12 wherein the contact surface compresses the web against the spool with increasing force as the web is wound upon the spool.

19. The retractor of claim 12 wherein the contact surface contacts the web with increasing force as the distance between the arm and base decreases during retraction of the web.

20. The retractor of claim 12 wherein the contact surface is spaced from the spool such that the contact surface only contacts the web during the last one to six turns of the web around the spool when the web is fully retracted.
